(19) United States
(12) Patent Application Publication
(10) Pub. No.: US 2026/0070648 A1
(43) Pub. Date: Mar. 12, 2026

(54) FASTENING DEVICE FOR CONNECTING TO A HOLDING DEVICE BY INTERLOCKING AND FRICTIONAL ENGAGEMENT, FASTENING SYSTEM FOR A SUPPORTING STRUCTURE OF A MEANS OF TRANSPORT, IN PARTICULAR FOR A STIFFENING PROFILE OF AN AIRCRAFT, AND AIRCRAFT

(71) Applicant: Airbus Operations GmbH, HAMBURG (DE)

(72) Inventors: Alexei VICHNIAKOV, HAMBURG (DE); Dennis BECK, HAMBURG (DE)

(21) Appl. No.: 19/318,528

(22) Filed: Sep. 4, 2025

(30) Foreign Application Priority Data
Sep. 11, 2024 (DE) 102024126080.7

(51) Int. Cl. B64C 1/06; F16B 5/02

(52) U.S. Cl. CPC B64C 1/069; F16B 5/0208; F16B 5/025

(57) ABSTRACT

A fastening device for connecting to a holding device by interlocking and frictional engagement, including a base body, which has along an axis of rotation a head portion and a handling portion, a plurality of elastically deformable segments arranged around the axis of rotation on the head portion and together form a thread which can be brought into engagement with a complementary thread of a holding device. The elastically deformable segments are configured such that, when the fastening device is pushed onto the complementary thread along the axis of rotation in a mounting direction, they will snap axially over the thread tips of the two threads, and a peripheral predetermined breaking point, which connects the head portion to the handling portion and is configured to break when there is a predetermined torque around the axis of rotation, so that the handling portion is separable from the head portion.

### FIELD OF THE INVENTION

This application claims the benefit of the German Patent Application No. 102024126080.7 filed on September 11, 2024, the entire disclosures of which are incorporated herein by way of reference.

The present invention relates to a fastening device for connecting to a holding device by interlocking and frictional engagement. The present invention also relates to a fastening system for a supporting structure of a means of transport, in particular for a stiffening profile of an aircraft, and to an aircraft with such a fastening system.

### BACKGROUND OF THE INVENTION

Modern vehicles such as aircraft and spacecraft are manufactured in sections that are pre-assembled. Fastening systems are required to attach further components to these sections. Especially in the aerospace sector, high precision is important in production.

In addition, the interior cladding of aircraft generally consists of individual elements in which essentially cabin insulation mats, sheets or panels are arranged alongside one another in a specific frame structure or supporting structure.

However, each portion and each component or each cabin insulation mat/sheet/panel of the aircraft has different production tolerances, which must be matched to one another during assembly. The mounting of the brackets is usually provided by adhesive bonding, riveting and screwing. The fastening of the interior cladding requires comparatively high assembly times and also expensive materials, such as for example titanium fasteners. However, the use of titanium fasteners is usually over dimensioned for the required forces that can be withstood.

### SUMMARY OF THE INVENTION

An object of the present invention is to provide a fastening device and/or a fastening system which can be quickly mounted and at the same time allows a predefined assembly quality.

According to a first aspect of the invention, a fastening device for connecting to a holding device by interlocking and frictional engagement is provided. The fastening device comprises a base body, which has along an axis of rotation a head portion and a handling portion, and a plurality of elastically deformable segments. The elastically deformable segments are arranged around the axis of rotation on the head portion and together form a thread which can be brought into engagement with a thread of a holding device complementary to the thread. The plurality of elastically deformable segments are designed such that, when the fastening device is pushed onto the complementary thread along the axis of rotation in a mounting direction, they will snap axially over the thread tips of the two threads. Furthermore, the fastening device comprises a peripheral predetermined breaking point, which connects the head portion to the handling portion. In addition, the peripheral predetermined breaking point is designed to break when there is a predetermined torque around the axis of rotation, so that the handling portion is separable from the head portion.

According to a second aspect of the invention, a fastening system for a supporting structure of a means of transport, in particular for a stiffening profile of an aircraft, is provided. The fastening system comprises a holding device for mounting on a supporting structure of a means of transport, wherein the holding device has at least one threaded pin. Furthermore, the fastening system comprises a fastening device according to the first aspect of the invention, wherein the plurality of elastically deformable segments can be brought into engagement with the at least one threaded pin by axially pushing the fastening device onto the at least one threaded pin.

According to a third aspect of the invention, an aircraft is provided. The aircraft comprises a stiffening profile and a fastening system according to the second aspect of the invention, wherein the fastening system is mounted on the stiffening profile.

An idea underlying the present invention is to provide an optimized concept for self-locking nuts for use in the mounting of brackets. For example, the fastening device according to the invention in combination with the holding device including the threaded pin can replace titanium fastening elements when mounting brackets or aluminum fastening elements when mounting A-brackets. The holding device or bracket is, for example, positioned on the supporting structure or the frame and mounted with the fastening device. The fastening device or locknut can, in this case, be attached and tightened hand-tight by a few turns. For example, the fastening device may be designed as a locknut or locking nut.

For example, the holding device may be designed for mounting on a stiffening profile of an aircraft. The stiffening profile is, for example, a former, a stringer, a rib, a spar, Pax and Cargo floor structures, a door frame structure or a system module. The stiffening profile may, for this purpose, have a hole, an opening or the like, through which the at least one threaded pin can penetrate. For the purposes of the present invention, a threaded pin generally refers to an essentially cylindrical rod or tube which at least partly has a thread, in particular the complementary thread. The thread may in this case be designed as an external thread or as an internal thread.

An advantage of the fastening device according to the invention is that already approved fastening technologies and/or materials can be used. Furthermore, known interface locations can be used, which means that no changes to the interface locations are necessary.

Assembly times and/or assembly costs can be reduced because of the large number of elastically deformable segments. In addition, a weight of the fastening device can be reduced, which when calculated over a complete aircraft can save weight. Specifically, with the fastening device according to the invention, the relatively expensive material titanium can be saved. For example, when mounting a single fastening system, the assembly time can be shortened.

Furthermore, organic or recycled materials can be used for the base body. Alternatively or in addition, the variety of materials can be reduced to facilitate material recycling. In particular, the base body, the thread formed by the segments or both can be compatible with known fastening structures.

In particular, if the complementary thread or the threaded pin extends axially over a significantly greater length than is required for sufficient fastening of the fastening device, the assembly time can be significantly reduced, since the axial pushing on of the fastening device can be performed much more quickly than the turning of a conventional locknut to create the same axial distance. Therefore, a length of the complementary thread or the threaded pin can be chosen independently of a mounting location, and, in particular, independently of a thickness to be clamped of the stiffening profile, whereby the means of transport can comprise multiple holding devices each with a complementary thread or threaded pin of a uniform length, without thereby affecting the assembly time.

Advantageous embodiments and developments will become apparent from the following description with reference to the figures.

According to one embodiment of the invention, the plurality of segments comprises at least three segments which are arranged evenly distributed around the axis of rotation. Thus, the segments can provide a resilient engagement in the complementary thread to ensure operational strength. In particular, the plurality of segments may comprise three, four, five or six segments which are arranged evenly distributed around the axis of rotation.

According to a further embodiment of the invention, the plurality of segments are elastically deformable in such a way that, when the fastening device is pushed on in the mounting direction, the plurality of segments spread elastically in order to snap over the thread tip and then deform back in order to be in engagement with the complementary thread.

According to a further embodiment of the invention, the head portion has a peripheral serration for manual rotation of the base body. Thus, the base body, in particular the head portion, can be turned by hand after the handling portion has been separated from the head portion. In this way, non-destructive dismantling can be provided. For example, the peripheral serration may have a cog-like geometry.

According to a further embodiment of the invention, when considered in a radial cross section, the head portion has a hexagonal outer contour. In this way, the base body, in particular the head portion, can be turned with the aid of a tool, for example with the aid of an open-ended wrench, after the handling portion has been separated from the head portion. This means that the head portion can be detached from the complementary thread as a result of the hexagonal outer contour. In this way, non-destructive dismantling can be provided. In addition, the hexagonal outer contour can be used in order, if necessary, to set a different torque with the aid of a torque wrench after the handling portion has been broken off.

According to a further embodiment of the invention, the base body has a through-opening which extends axially along the axis of rotation. Thus, an element bearing the complementary thread, for example a threaded pin, can be made to be of any length, wherein the threaded pin can protrude through the through-opening.

According to a further embodiment of the invention, the plurality of segments are arranged on an inner wall of the head portion, so that the head portion radially delimits the plurality of segments.

According to a further embodiment of the invention, the holding device comprises at least two, three or four threaded pins, which are oriented in the same direction while spaced apart from one another.

Optionally, the holding device may have an internal thread that is oriented away from the at least one threaded pin. For example, at least one threaded pin may be made of plastic.

Furthermore, the fastening system may have a mounting plate device for providing a further mounting interface, wherein the mounting plate device is arranged between the holding device and the fastening device, wherein the at least one threaded pin penetrates the mounting plate device.

According to a further aspect of the invention, an assembly method may be provided. The assembly method comprises, by way of example, the following steps:

- providing a holding device on a supporting structure of a means of transport,

- axially pushing a fastening device, which has a plurality of elastically deformable segments which are arranged around an axis of rotation on a head portion of the fastening device and together form a thread, onto a thread of the holding device complementary to the thread along the axis of rotation in a mounting direction, wherein the elastically deformable segments snap over the thread tips of the two threads.

- rotating the fastening device, wherein a peripheral predetermined breaking point, which connects the head portion to a handling portion of the fastening device, breaks when there is a predetermined torque about the axis of rotation, so that the handling portion is separated from the head portion.

In particular, the fastening device can be rotated in engagement with the thread after the fastening device has been pushed onto the complementary thread.

If appropriate, the above embodiments and developments can be combined with one another in any way desired. In particular, all of the features of the device are transferable to the associated method, and vice versa. Further possible embodiments, developments and implementations of the invention also comprise combinations of features of the invention described above or below with regard to the exemplary embodiments that have not been specified explicitly. In particular, a person skilled in the art will also add individual aspects as improvements or additions to the respective basic form of the present invention.

### BRIEF DESCRIPTION OF THE DRAWINGS

The present invention is explained in more detail below on the basis of exemplary embodiments with reference to the accompanying figures of the drawings. In the figures:

FIG. 1 shows a schematic sectional representation of a fastening system, which is mounted on a stiffening profile, according to an exemplary embodiment of the invention;

FIG. 2 shows a schematic sectional representation of a fastening system, which is mounted on a stiffening profile, according to a further exemplary embodiment of the invention;

FIG. 3 shows a schematic sectional representation of a fastening device for connecting to a holding device by interlocking and frictional engagement according to a further exemplary embodiment of the invention;

FIG. 4 shows a perspective view of the fastening device from FIG. 3; and

FIG. 5 shows a schematic view of an aircraft according to a further exemplary embodiment of the invention with a fastening system for a stiffening profile of the aircraft.

In the figures of the drawing, elements, features and components that are the same, functionally the same and act the same are respectively provided with the same designations unless stated otherwise.

Although specific embodiments and developments are shown and described here, a person skilled in the art will prefer that a large number of alternative and/or equivalent embodiments can replace the specific exemplary embodiments shown and described without departing from the scope of the present invention. This application is generally intended to cover all modifications of or changes to the specific exemplary embodiments described herein.

The accompanying figures are intended to convey further understanding of embodiments of the invention and serve in conjunction with the description for explaining principles and concepts of the invention. Other exemplary embodiments and many of the stated advantages will become apparent with reference to the drawings. The drawings are to be understood only as being schematic drawings, and the elements of the drawings are not necessarily shown true to scale relative to one another. Direction-indicating terminology such as, for instance, “top”, “bottom”, “left”, “right”, “above”, “below”, “horizontal”, “vertical”, “front”, “rear” and similar indications are used only for explanatory purposes and do not serve to restrict the generality to specific configurations as shown in the figures.

### DETAILED DESCRIPTION OF THE PREFERRED EMBODIMENTS

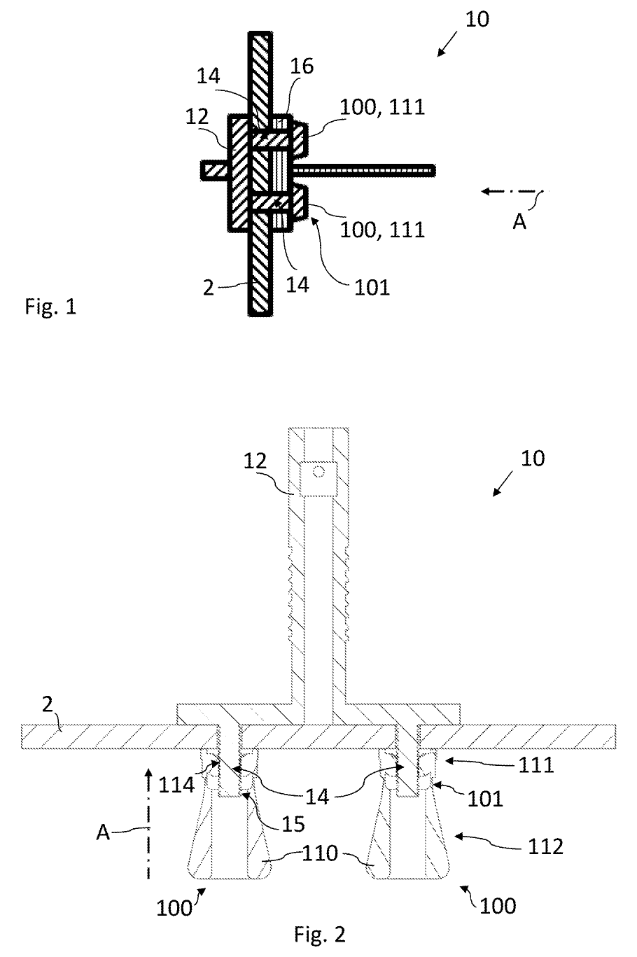

FIG. 1 shows a schematic sectional representation of a fastening system 10, which is mounted on a stiffening profile 2, according to an exemplary embodiment of the invention.

The fastening system 10 is designed, for example, for a supporting structure of a means of transport, in particular for the stiffening profile 2 of an aircraft 1. The fastening system 10 comprises, by way of example, a holding device 12 and a fastening device 100.

The holding device 12 has at least one threaded pin 14. The stiffening profile 2 may for this purpose have a hole, an opening or the like, through which the at least one threaded pin can penetrate. For example, the holding device 12 may comprise two threaded pins 14, which are oriented in the same direction while spaced apart from one another, as shown by way of example in FIG. 1. For example, the at least one threaded pin 14 may be made of a plastic material.

The fastening device 100 is designed, in particular, for connecting to the holding device 12 by interlocking and frictional engagement. The fastening device 100 here comprises a base body, a plurality of elastically deformable segments and a peripheral predetermined breaking point 101.

Along an axis of rotation, the base body has a head portion 111 and a handling portion (already separated from the head portion in the finished assembled state and therefore not shown).

The plurality of elastically deformable segments are arranged around the axis of rotation on the head portion 111 and together form a thread (not shown) which can be brought into engagement with a thread of the holding device 12 complementary to the thread. Furthermore, the plurality of elastically deformable segments are designed such that, when the fastening device 100 is pushed onto the complementary thread along the axis of rotation in a mounting direction A, they will snap axially over the thread tips of the two threads.

The peripheral predetermined breaking point 101 connects the head portion 111 to the handling portion and is designed to break when there is a predetermined torque around the axis of rotation, so that the handling portion is separated from the head portion 111. This assembly state is already reached in FIG. 1, which is why the handling portion is missing in the drawing.

The plurality of elastically deformable segments 113 can be brought into engagement with the at least one threaded pin 14 by axially pushing the fastening device 100 onto the at least one threaded pin 14.

Furthermore, the fastening system 10 may comprise a mounting plate device 16 for providing a further mounting interface, wherein the mounting plate device 16 is arranged between the holding device 12 and the fastening device 10, wherein the at least one threaded pin 14 penetrates the mounting plate device 16. Furthermore, the mounting plate device 16 may have a mechanical interface for connection to a corresponding fastening means, which protrudes from the mounting plate device 16.

FIG. 2 shows a schematic sectional representation of a fastening system 10, which is mounted on a stiffening profile 2, according to a further exemplary embodiment of the invention.

The fastening system 10 according to FIG. 2 essentially comprises the same features as the fastening system 10 from FIG. 1, unless described otherwise below.

Here, the fastening system 10 does not include a mounting plate device 16. By way of example, the fastening system 10 consists of the holding device 12 and the fastening device 100.

As a difference from FIG. 1, here the fastening devices 100 have already been pushed axially onto the respective threaded pin 14, but have not yet been screwed with the predetermined torque. Consequently, in FIG. 2 the handling portion 112, the thread 114 formed by the plurality of elastically deformable segments and the complementary thread 15 are shown.

As also in FIG. 1, here in FIG. 2 the holding device 12 is arranged by way of example on a first side of the stiffening profile 2, wherein the fastening device 100 is arranged on a second side facing away from the first side. This means that the stiffening profile 2 is clamped between the holding device 12 and the fastening device 100.

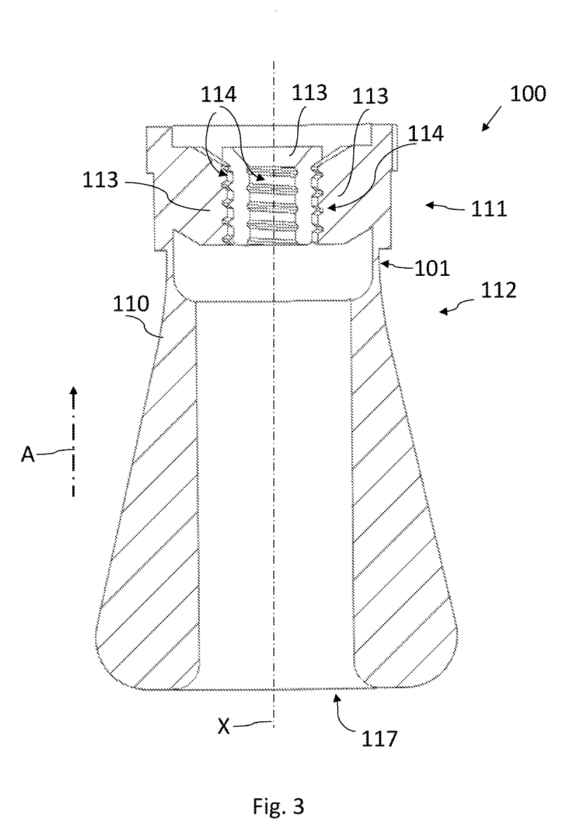

FIG. 3 shows a schematic sectional representation of a fastening device 100 for connecting to a holding device 12 by interlocking and frictional engagement according to a further exemplary embodiment of the invention.

The fastening device 100 here comprises, by way of example, a base body 110, a plurality of elastically deformable segments 113 and a peripheral predetermined breaking point 101.

The base body 110 has, along an axis of rotation X, a head portion 111 and a handling portion 112. The base body 110 may, for example, be formed as essentially axially symmetrical, in particular essentially rotationally symmetrical.

The plurality of elastically deformable segments 113 are arranged around the axis of rotation X on the head portion 111 and together form a thread 114 which can be brought in engagement with a thread 15 of a holding device 12 complementary to the thread 114. In addition, the plurality of elastically deformable segments 113 are designed such that, when the fastening device 100 is pushed onto the complementary thread 15 along the axis of rotation X in a mounting direction A, they will snap axially over the thread tips of the two threads 114, 15. The thread 114 formed by the plurality of segments 113 may be interrupted in a circumferential direction between adjacent segments, ensuring that the thread is always functional. The elastically deformable segments 113 are also designed to block an axial displacement of the fastening device 100 relative to the complementary thread 15 against the mounting direction A.

For example, the plurality of segments 113 may comprise four segments, which are arranged evenly distributed around the axis of rotation X, as illustrated in FIG. 3, but is not limited to this number. Alternatively, the plurality of segments 113 may comprise three, five or six segments, which are arranged evenly distributed around the axis of rotation X. Furthermore, the plurality of segments 113 may be elastically deformable in such a way that, when the fastening device 100 is pushed on in the mounting direction A, the plurality of segments 113 spread elastically in order to snap over the thread tip and then deform back in order to be in engagement with the complementary thread 15.

Furthermore, the plurality of segments 113 may be arranged on an inner wall of the head portion 111, so that the head portion 111 radially delimits the plurality of segments 113.

The peripheral predetermined breaking point 101 connects the head portion 111 to the handling portion 112 and is designed to break when there is a predetermined torque around the axis of rotation X, so that the handling portion 112 is separable from the head portion 111.

Optionally, the base body 110 may have a through-opening 117, which extends axially along the axis of rotation X. Thus, an element bearing the complementary thread 15, for example a threaded pin 14, can be made to be of any length, wherein the threaded pin 14 can protrude through the through-opening 117.

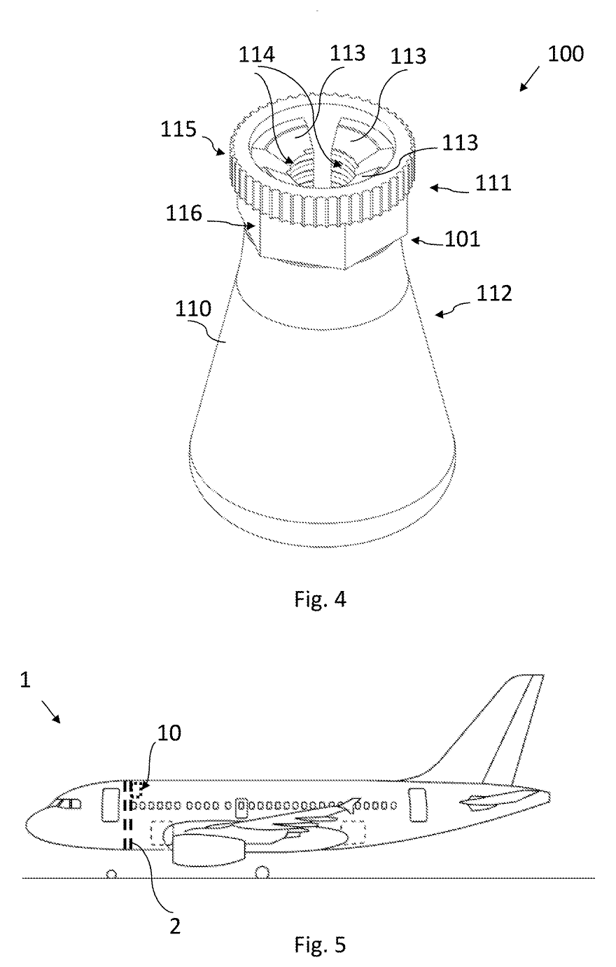

FIG. 4 shows a perspective view of the fastening device 100 from FIG. 3.

FIG. 4 shows that the head portion 111 may optionally have a peripheral serration 115 for manual rotation of the base body 110. Thus, the base body 110, in particular the head portion 111, can be turned by hand after the handling portion 112 has been separated from the head portion 111. In this way, non-destructive dismantling can be provided. For example, the peripheral serration 115 may have a cog-like geometry.

Alternatively or in addition, when considered in a radial cross section, the head portion 111 may have a hexagonal outer contour 116. In this way, the base body 110, in particular the head portion 111, can be turned with the aid of a tool, for example with the aid of an open-ended wrench, after the handling portion 112 has been separated from the head portion 111. This means that the head portion 111 can be detached from the complementary thread 15 as a result of the hexagonal outer contour 116. In this way, non-destructive dismantling can be provided. In addition, the hexagonal outer contour 116 can be used in order, if necessary, to set a different torque with the aid of a torque wrench after the handling portion 112 has been broken off.

FIG. 5 shows a schematic view of an aircraft 1 according to an exemplary embodiment of the invention with a fastening system 10 for a stiffening profile 2 of the aircraft 1.

The aircraft 1 comprises, by way of example, the stiffening profile 2 and the fastening system 10, wherein the fastening system 10 is mounted on the stiffening profile 2.

The fastening system 10 may, for example, be designed as provided by an exemplary embodiment according to FIGS. 1 or 2. The base body 110 is, for example, fastened on a stiffening profile of a fuselage structure of the aircraft 1. This means that great static forces can be absorbed by way of the fastening system 10.

In order to improve the stringency of the representation, in the detailed description above various features have been combined in one or more examples. However, it should be clear in this case that the description above is only of an illustrative and in no way restrictive nature. It is used to cover all alternatives, modifications and equivalents of the various features and exemplary embodiments. Many other examples will be immediately and directly clear to a person skilled in the art on the basis of their technical knowledge in view of the description above.

The exemplary embodiments were chosen and described in order to be able to represent the principles on which the invention is based and their possible uses in practice in the best possible manner. As a result, experts can optimally modify and use the invention and its various exemplary embodiments for the intended purpose. In the claims and the description, the terms “containing” and “having” are used as neutral concepts for the corresponding term “comprising”.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### List of reference signs

1 Aircraft

2 Stiffening profile

10 Fastening system

12 Holding device

14 Threaded pin

15 Complementary thread

16 Mounting plate device

100 Fastening device

101 Predetermined breaking point

110 Base body

111 Head portion

112 Handling portion

113 Elastically deformable segments

114 Thread

115 Serration

116 Hexagonal outer contour

117 Through-hole

A Mounting direction

X Axis of rotation

1. A fastening device configured to connect to a holding device by interlocking and frictional engagement, comprising:
a base body, which has, along an axis of rotation, a head portion and a handling portion;
a plurality of elastically deformable segments arranged around the axis of rotation on the head portion and together form a first thread which is configured to be brought into engagement with a holding device thread complementary to the first thread, wherein the plurality of elastically deformable segments are configured such that, when the fastening device is pushed onto the complementary holding device thread along the axis of rotation in a mounting direction, the plurality of deformable segments will snap axially over thread tips of the first thread and the holding device thread; and
a peripheral predetermined breaking point, which connects the head portion to the handling portion and is configured to break when there is a predetermined torque around the axis of rotation, so that the handling portion is separable from the head portion.

2. The fastening device as claimed in claim 1, wherein the plurality of segments comprises at least three segments which are arranged evenly distributed around the axis of rotation.

3. The fastening device as claimed in claim 2, wherein the plurality of segments comprises three to six segments.

4. The fastening device as claimed in claim 1, wherein the plurality of segments are elastically deformable in such a way that, when the fastening device is pushed on in the mounting direction, the plurality of segments spread elastically in order to snap over the thread tips and then deform back in order to be in engagement with the complementary holding device thread.

5. The fastening device as claimed in claim 1, wherein the head portion has a peripheral serration configured to assist in manual rotation of the base body.

6. The fastening device as claimed in claim 1, wherein, when viewed in a radial cross section, the head portion has a hexagonal outer contour.

7. The fastening device as claimed in claim 1, wherein the base body has a through-opening, which extends axially along the axis of rotation.

8. The fastening device as claimed in claim 1, wherein the plurality of segments are arranged on an inner wall of the head portion, so that the head portion radially delimits the plurality of segments.

9. A fastening system for a supporting structure of a means of transport, comprising:
a holding device configured to mount a supporting structure of a means of transport,
wherein the holding device has at least one threaded pin; and
a fastening device as claimed in claim 1,
wherein the plurality of elastically deformable segments are configured to be brought into engagement with the at least one threaded pin by axially pushing the fastening device onto the at least one threaded pin.

10. The fastening system as claimed in claim 9, wherein the supporting structure comprises a stiffening profile of an aircraft.

11. The fastening system as claimed in claim 9, wherein the holding device comprises at least two threaded pins, which are oriented in the same direction while being spaced apart from one another.

12. The fastening system as claimed in claim 9, wherein the holding device comprises at least four threaded pins, which are oriented in the same direction while being spaced apart from one another.

13. An aircraft comprising a stiffening profile and a fastening system as claimed in claim 10, wherein the fastening system is mounted on the stiffening profile.
